(19) United States
(12) Patent Application Publication
(10) Pub. No.: US 2009/0249830 A1
(43) Pub. Date: Oct. 8, 2009

(54) Process For Producing Variable Gaseous Nitrogen And Variable Gaseous Oxygen By Air Distillation

(75) Inventor: Patrick Le Bot, Vincennes (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour l'Etude et l'Exploitation Des Procedes Georges Claude, Paris (FR)

(21) Appl. No.: 12/419,525

(22) Filed: Apr. 7, 2009

(30) Foreign Application Priority Data
Apr. 7, 2008 (FR) 0852299

(51) Int. Cl. F25J 3/00; F25J 3/04; F17C 9/02

(52) U.S. Cl. 62/643; 62/648; 62/654; 62/50.2

(57) ABSTRACT

A process for producing variable gaseous nitrogen and variable gaseous oxygen by air distillation, during a period of high demand for gaseous nitrogen and for gaseous oxygen, liquid nitrogen is drawn off from a storage vessel, the liquid nitrogen is vaporized by heat exchange with a first flow of compressed, purified and cooled air, the vaporized nitrogen is sent to the customer and the first flow of liquefied air produced by the heat exchange is sent to a liquefied air storage vessel, liquid oxygen is drawn off from a storage vessel, the liquid oxygen is vaporized by heat exchange with a second flow of compressed, purified and cooled air, the vaporized oxygen is sent to the customer and the second flow of liquefied air is sent to the storage vessel.

This application claims priority to French Patent Application FR 0852299 filed Apr. 7, 2008.

### BACKGROUND

The present invention relates to the production of a variable nitrogen flow and a variable gaseous oxygen flow by distillation of air. It firstly relates to a process of the type in which a variable amount of nitrogen is stored in liquid form in a first tank from which a variable nitrogen flow is removed and vaporized with, correspondingly, storage of air in liquid form in a second tank.

In a known process of this type described in EP-A-0422974 used in actual installations and known under the name “switch process”, the vaporization and the condensation of oxygen correspond to a condensation and to a vaporization of air, the heat exchanges being carried out in a heat exchanger outside of the air distillation unit. This process makes it possible to produce variable amounts of pressurized gaseous oxygen but does not make it possible to produce pressurized gaseous nitrogen. In certain applications such as IGCCs, the air separation unit simultaneously supplies an oxygen product and a nitrogen product, the outputs of which always vary proportionally. For example, if the oxygen output varies by ±20% relative to a nominal production, the nitrogen output will have to increase simultaneously by ±20% relative to a nominal production. According to the prior art, it is possible to meet this need:

either with an air separation unit that produces 100% oxygen and 100% nitrogen in a period of high demand and that reduces the charge to 50% or that vents a portion to the atmosphere in an off-peak period. The unit is sized for 100% production;

or with an air separation unit equipped with a switch system for the oxygen. The unit will be sized for the average of the molecules of oxygen required, namely 75%. This is an economical solution for oxygen, but then the 100% nitrogen requirement could not be satisfied in the absence of a sufficient air flow rate.

### SUMMARY

One objective of the present invention is to overcome at least one failing of the prior art, in particular to provide an economical solution for satisfying the stated demand for nitrogen and for oxygen.

One subject of the invention is a process for producing a variable flow of gaseous nitrogen and a variable flow of gaseous oxygen by air distillation, in which a compressed gaseous nitrogen flow and a pressurized gaseous oxygen flow are produced by distillation of a compressed, purified and cooled air flow in at least one column of a system of columns, they are sent to the customer and

a) during a period of high demand for gaseous nitrogen and for gaseous oxygen, liquid nitrogen is drawn off from a liquid nitrogen storage vessel, it is vaporized by heat exchange with a first flow of compressed, purified and cooled air, the vaporized nitrogen is sent to the customer and the first flow of liquefied air produced by the heat exchange is sent to a liquefied air storage vessel, liquid oxygen is drawn off from a liquid oxygen storage vessel, it is vaporized by heat exchange with a second flow of compressed, purified and cooled air, the vaporized oxygen is sent to the customer and at least one portion of the second flow of liquefied air produced by the heat exchange is sent to the liquefied air storage vessel;

b) during a period of reduced demand for gaseous nitrogen and for gaseous oxygen, a third flow of liquid air is drawn off from a liquefied air storage vessel and it is vaporized by heat exchange with a flow of gaseous nitrogen taken from the flow sent to the customer, the third flow of vaporized air is sent to the system of columns and the nitrogen liquefied by the heat exchange is sent to the liquid nitrogen storage vessel, a fourth flow of liquid air is drawn off from a liquefied air storage vessel, the fourth flow of liquefied air is sent to the system of columns in liquid form and liquefied oxygen is sent from the system of columns to the liquid oxygen storage vessel.

The liquefied air storage vessel to which the first flow of liquefied air is sent may be that from which the third and/or the fourth flow of liquid air is drawn off.

The liquid oxygen may be vaporized by heat exchange with any air to be vaporized in the main exchange line.

Optionally, the third flow of vaporized air is sent to the distillation by mixing it with the air downstream of an air purification process and upstream of the cooling in the main exchange line.

According to another aspect of the invention, an installation is provided for separating air by cryogenic distillation, comprising a system of columns, a purification unit, a main exchange line, a liquid nitrogen storage vessel, a liquid oxygen storage vessel and at least one liquefied air storage vessel, a nitrogen compressor, a first exchanger, a second exchanger, means for sending air to be distilled to the system of columns, means for sending a first flow of air to the first exchanger, means for sending the first flow of air from the first exchanger to the liquefied air storage vessel, means for sending a second flow of air to the second exchanger, means for sending the second flow of air from the second exchanger to the liquefied air storage vessel or to another liquefied air storage vessel, means for removing a third flow of liquefied air from the storage vessel fed by the first flow and for sending it to the first exchanger in order to vaporize it, means for sending the third vaporized flow to the distillation, means for removing a fourth flow of liquid air from the storage vessel fed by the second flow of liquefied air and for sending it to the distillation, means for sending a variable flow of gaseous nitrogen from the system of columns to the first exchanger in order to condense it, means for sending the condensed nitrogen from the first exchanger to the nitrogen storage vessel, means for removing liquid nitrogen from the storage vessel and for sending it to the first exchanger in order to vaporize it, means for sending a flow of liquid oxygen from the system of columns to the oxygen storage vessel and means for sending liquid oxygen from the oxygen storage vessel to the second exchanger.

According to other aspects of the invention, it is provided that:

the second exchanger is the main exchange line of the unit;

only nitrogen and air originating from or intended for the air storage vessel exchange heat in the first exchanger;

the liquid oxygen and optionally the liquid air enter the respective storage vessel via the top of the storage vessel;

the liquid nitrogen and optionally the liquid air enter the respective storage vessel via the bottom of the storage vessel.

The installation may comprise means for sending the third flow of vaporized air to the distillation at a point upstream of the main exchange line and downstream of the purification unit, and optionally means for modifying the pressure of the third flow upstream of this point.

Unlike the process from EP-A-0422974, in this process, whether the oxygen and nitrogen demands are high or low, the flows of each fluid introduced into the distillation unit and of each fluid drawn off from this unit are not kept constant, however, as in EP-A-0422974, the total flow of air to be treated is varied in the same way as the flow of air condensed by vaporization of oxygen.

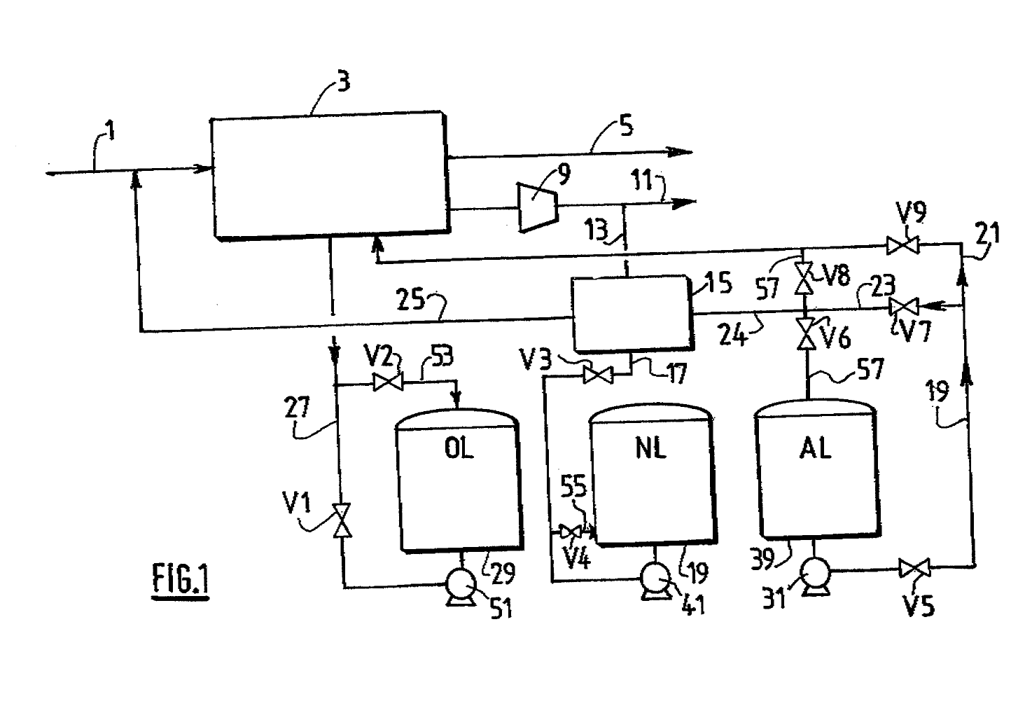

FIG. 1 is a representation of the operation of an air separation process according to one embodiment of the invention.

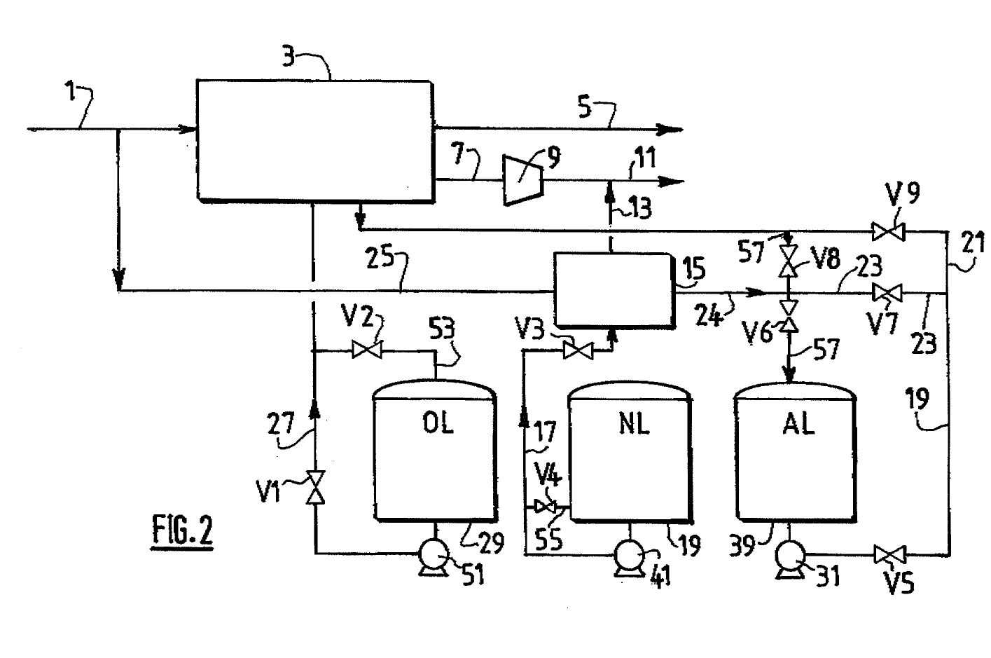

FIG. 2 is a representation of the operation of an air separation process according to another embodiment of the invention.

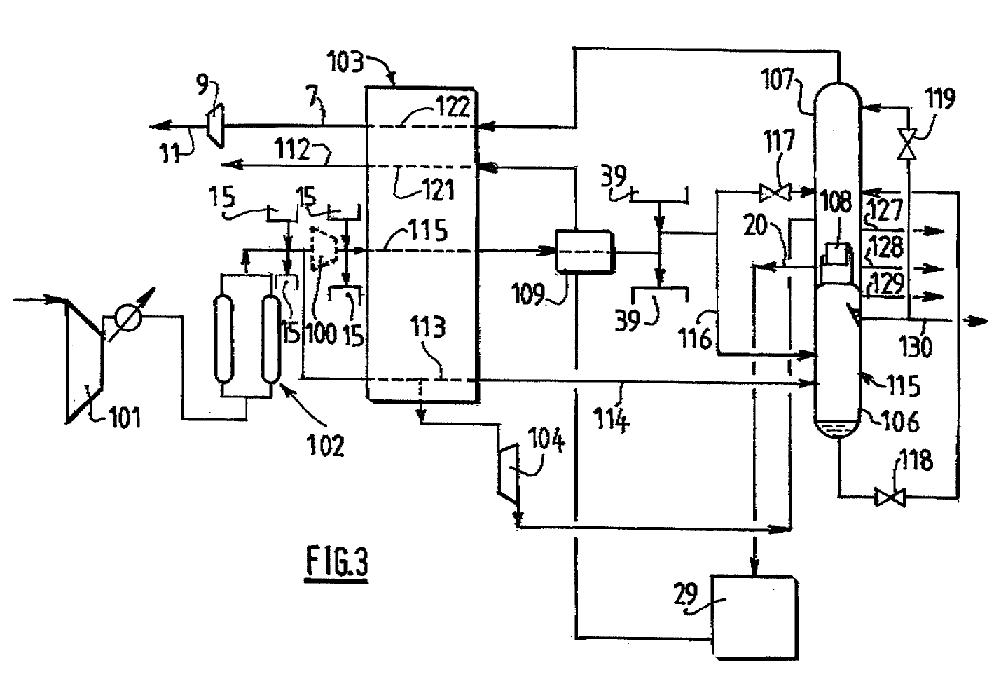

FIG. 3 is a schematic representation of an embodiment of one part of an installation conforming to the invention.

### DETAILED DESCRIPTION

Exemplary embodiments of the invention will now be described with respect to the appended drawings, in which FIGS. 1 and 2 represent two different operations of an air separation process according to the invention and FIG. 3 schematically represents an embodiment of one part of an installation conforming to the invention.

In FIG. 1, an air separation unit having a cold box 3 is supplied with a flow of cooled, purified and compressed air 1. This unit produces gaseous oxygen 5, optionally under pressure, gaseous nitrogen 7, pressurized by a compressor 9, and liquid oxygen 27. It may also produce other products, such as argon. The unit also comprises storage vessels for liquid oxygen 29, for liquid nitrogen 19 and for liquid air 39, at least one of these storage vessels possibly being located outside or inside the cold box.

When the gaseous nitrogen requirements of the customer are below a given threshold, a portion 13 of the nitrogen compressed by the compressor 9 is sent to an indirect-contact heat exchanger 15 where it exchanges heat with a flow of liquid air 19 that comes from the liquid air storage vessel 39 through the ducts 23,24, the valves V5, V7 being open and the liquid air pump 31 being in operation. The valve V9 is closed. The vaporized air is sent via the duct 25 to the air separation unit, as illustrated in greater detail in FIG. 3.

The nitrogen 17 thus liquefied in the exchanger 15 is sent to the liquid nitrogen storage vessel 19 through the valve V4 and the duct 55. The liquid nitrogen pump 41 is not operating and the valve V3 is open.

Since, in general, the gaseous oxygen requirements are below a given threshold at the same time as the nitrogen requirements decrease, liquid oxygen 27 coming from the unit 3 is sent to the top of the liquid oxygen storage vessel through the valve V2 and the duct 53. The valve V1 is closed and the liquid oxygen pump 51 is not operating.

Another portion of the liquid air 19 is sent to the air separation unit 3 through the duct 21 and the valve V9, to compensate for the lack of liquid in the air separation unit.

Gaseous oxygen 5 is drawn off from the separation unit as product.

When the nitrogen requirements of the customer are above a given threshold, the unit operates as illustrated in FIG. 2. A flow of compressed, purified and cooled air 25 is taken from the flow of air intended for the air separation unit 3, as illustrated in greater detail in FIG. 3. This flow is sent to the exchanger 15 where it exchanges heat with the liquid nitrogen drawn off from the storage vessel 19 through the duct 17 and the valve V3 via the pump 41. The vaporized nitrogen 13 serves as a supplement for the nitrogen coming directly from the compressor 9 and is sent to the customer. The air liquefied in the exchanger 15 passes through the ducts 57 and the valve V6, the valve V7 being closed, into the storage vessel 39, via the top or the bottom.

At the same time, gaseous oxygen is produced through the duct 5. Liquid oxygen is drawn off from the storage vessel 29 and is sent through the valve V2 and the duct 27 to the air separation unit 3, as illustrated in greater detail in FIG. 3. Another portion of liquid air coming from the air separation unit is sent to the storage vessel 39 through the valves V8,V6 and the ducts 55,57.

The installation represented in FIG. 3 shows, in greater detail, the contents of the cold box 3 from FIGS. 1 and 2, and also other components 101,102,100 outside of the cold box. It essentially comprises a main air compressor 101 having a variable flow, for example of the rotating-blade centrifuge type, an adsorption purification unit 102, a heat exchange line 103, a turbine 104 for maintaining the coldness, optionally a booster compressor 100, an air distillation unit 105 composed of a double column itself comprising a medium-pressure column 106 surmounted by a low-pressure column 107 and a vaporizer-condenser 108, an auxiliary heat exchanger 9, a pump 24, a liquid oxygen tank 29 and a liquefied air tank 39. This installation is intended to produce a variable flow of gaseous oxygen via a duct 112, under a pressure slightly above atmospheric pressure, and also a variable flow of gaseous nitrogen.

To describe the operation of this installation, it will firstly be assumed that the gaseous oxygen demand in the duct 112 and the gaseous nitrogen demand 11 are constant and equal to the nominal production, i.e. 20% of the nominal air flow compressed by the compressor 101 for oxygen. Throughout the present document, the pressures indicated are approximate absolute pressures, and the flows are molar flows.

The nominal flow of air to be treated, compressed to 6 bar by the compressor 101, cooled to ambient temperature and purified in the unit 102, is divided into two streams each having a constant flow:

a first stream is cooled in passages 113 of the exchange line; one portion exits this exchange line after a partial cooling, is expanded to 1 bar in the turbine 104 and is injected into the low-pressure column 107 close to its dew point; the rest continues to be cooled to close to its dew point under 6 bar, then is injected into the bottom of the medium-pressure column 106 via a duct 114;

a second stream is optionally boosted by the booster compressor 100 illustrated by dotted lines, cooled to close to its dew point in passages of the exchange line, then condensed in the second exchanger 109 and stored in liquid form in the tank 39. A constant flow of liquefied air is drawn off from the bottom of this tank and is divided into a first constant flow under 6 bar sent into the medium-pressure column via a duct 116, and a second constant flow expanded to 1 bar in an expansion valve 117 then injected into the low-pressure column 107.

The vaporizer-condenser 108 vaporizes a constant flow of liquid oxygen in the bottom of the low-pressure column by condensing an approximately equal flow of nitrogen from the top of the medium-pressure column. “Rich liquid” (oxygen-enriched air) withdrawn at the bottom of the medium-pressure column and expanded to 1 bar in an expansion valve 118 is injected at an intermediate level of the low-pressure column, and “lean liquid” (substantially pure nitrogen) withdrawn at the top of the medium-pressure column and expanded to 1 bar in an expansion valve 119 is injected into the top of the low-pressure column.

A constant flow of liquid oxygen, corresponding to 20% of the incoming air flow, passes via a duct 20 into the storage vessel 29. An identical constant flow of liquid oxygen is drawn off from the bottom of this tank, pressurized in the pump 24, vaporized in the exchanger 109, heated in the passages 121 of the exchange line and supplied to the production duct 112.

In order to be able to carry out this vaporization, the corresponding flow of air is optionally boosted to a pressure somewhat higher than the oxygen vaporization pressure by the booster compressor 100, condensed in a second exchanger 109, then optionally expanded to 6 bar in an expansion valve V6 before being stored in the storage vessel 39. In the figure, this exchanger 109 is an independent exchanger where liquid oxygen is vaporized by heat exchange with a portion of the air to be distilled, optionally the boosted portion. However, vaporizing the oxygen that comes from the storage vessel 29 in the main exchange line 103 can be envisaged. In this case, the exchanger 109 would be removed.

Moreover, a constant flow of impure nitrogen, drawn off from the top of the low-pressure column, is heated in passages 122 of the exchange line and sent via a duct 7 to the compressor 9 to serve as product 11.

A flow of gaseous nitrogen is drawn off from the top of the medium-pressure column 106, optionally compressed in the compressor 9 and sent to the customer. Otherwise, the nitrogen can be drawn off in liquid form, pumped and vaporized upstream of the compressor 9.

In normal operation, no flow circulates in the ducts 13,17 and 23,24 from FIGS. 1 and 2.

When the gaseous oxygen demand and the gaseous nitrogen demand increase, liquid oxygen is sent from the storage vessel 29 to the exchanger 3 and a greater flow of oxygen is vaporized in the exchanger 3. This increases the flow of air condensed in this exchanger, which creates a need for additional air at this exchanger, in the passages of this exchange line. The setting of the blades of the compressor 1 is then modified so as to allow in this additional air flow. The level of the liquid in the storage vessel 29 drops, and the level in the storage vessel 39 rises.

At the same time, in order to increase the amount of nitrogen produced, nitrogen 43, previously liquefied and stored in the storage vessel 37, is brought to the required pressure by pressurization in the pump 41 and vaporized in the first exchanger 15 by heat exchange with air in the duct 25. The gaseous air is taken downstream of the purification unit and upstream of the exchange line 103. If there is a booster compressor 100, it may be taken upstream or downstream of this. The air may be boosted or expanded in the duct 25, depending on the vaporization pressure required. The pressurized air that comes from the duct 25 is liquefied, optionally subcooled and stored in the storage vessel 39, optionally at a pressure different from its condensation pressure. The pressurized and vaporized nitrogen that is at ambient temperature will be introduced as a supplement to the production 7 from the medium-pressure column. The nitrogen may be produced alternatively or additionally by the low-pressure column 107 or by an intermediate-pressure column when the double column is replaced by a triple column, for example of the Etienne type.

Conversely, when the gaseous oxygen demand and the gaseous nitrogen demand decrease, liquid oxygen is sent from the low-pressure column 107 to the storage vessel 29 and a reduced flow of oxygen is vaporized in the exchanger 9. This reduces the flow of air condensed in this exchanger, and therefore also the flow of air circulating in the passages 15 of the exchange line. The setting of the blades of the compressor 1 is then modified so as to decrease the flow of atmospheric air sucked in accordingly.

It is therefore seen that it is possible to respond to the variation in the gaseous oxygen demand by a simple modification of the setting of the blades of the compressor 1 and of the booster compressor 25, which can be carried out simply and almost instantaneously.

In order to reduce the flow of nitrogen, compressed nitrogen is sent via the duct 13 to the exchanger 15 and the storage vessel 19. The air thus vaporized is sent downstream of the purification unit 102 and upstream of the exchange line 103. If there is a booster compressor 100, the air may be sent upstream or downstream of this, depending on its pressure. It may be necessary to boost or expand the air of the duct 25 before mixing it with the air coming from the purification unit.

Due to its simplicity and its efficiency, the invention is particularly suitable for conferring flexibility on installations for producing oxygen with oxygen demands that vary frequently and rapidly.

It should be noted that the invention also applies to the case where, the oxygen demand always being above a given minimum value, a constant flow of gaseous oxygen equal to this minimum value is drawn off directly from the bottom of the low-pressure column 107 via a duct 27, as indicated by the chain-dotted line in FIG. 1, then heated in the exchange line. This variant makes it possible to reduce the capacity of the storage vessels. Likewise, constant productions of liquid oxygen and/or of liquid nitrogen can be provided simultaneously by the double column, via ducts 28 and/or 30, also as indicated by the chain-dotted line in FIG. 3.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A process for the production of a variable flow of gaseous nitrogen and a variable flow of gaseous oxygen by air distillation, comprising:
a) producing a compressed gaseous nitrogen flow and a pressurized gaseous oxygen flow by distillation of a compressed, purified and cooled air flow in at least one column of a system of columns,
b) sending said compressed gaseous nitrogen flow and said pressurized gaseous oxygen flow to a customer, wherein
c) during a period of high demand for gaseous nitrogen and for gaseous oxygen, liquid nitrogen is drawn off from a liquid nitrogen storage vessel, said liquid nitrogen is vaporized by heat exchange with a first flow of compressed, purified and cooled air, the vaporized nitrogen is sent to the customer and the first flow of liquefied air produced by the heat exchange is sent to a liquefied air storage vessel, liquid oxygen is drawn off from a liquid oxygen storage vessel, said liquid oxygen is vaporized by heat exchange with a second flow of compressed, purified and cooled air, the vaporized oxygen is sent to the customer and at least one portion of the second flow of liquefied air produced by the heat exchange is sent to the liquefied air storage vessel;
d) during a period of reduced demand for gaseous nitrogen and for gaseous oxygen, a third flow of liquid air is drawn off from the liquefied air storage vessel and it is vaporized by heat exchange with a flow of gaseous nitrogen taken from the flow sent to the customer, the third flow of vaporized air is sent to the system of columns and the nitrogen liquefied by the heat exchange is sent to the liquid nitrogen storage vessel, a fourth flow of liquid air is drawn off from a liquefied air storage vessel, the fourth flow of liquefied air is sent to the system of columns in liquid form and liquefied oxygen is sent from the system of columns to the liquid oxygen storage vessel.

2. The process according to claim 1, in which the liquefied air storage vessel is that from which the third or the fourth flow of liquid air is drawn off.

3. The process according to claim 1, in which the liquid oxygen is vaporized by heat exchange with any air to be vaporized in a main exchange line.

4. An installation for separating air by cryogenic distillation, comprising
a system of columns, a purification unit, a main exchange line, a liquid nitrogen storage vessel, a liquid oxygen storage vessel and at least one liquefied air storage vessel, a nitrogen compressor, a first exchanger, a second exchanger, means for sending air to be distilled to the system of columns, means for sending a first flow of air to the first exchanger, means for sending the first flow of air from the first exchanger to the liquefied air storage vessel, means for sending a second flow of air to the second exchanger, means for sending the second flow of air from the second exchanger to the liquefied air storage vessel or to another liquefied air storage vessel, means for removing a third flow of liquefied air from the storage vessel fed by the first flow and for sending it to the first exchanger in order to vaporize it, means for sending the third vaporized flow to the distillation, means for removing a fourth flow of liquid air from the storage vessel fed by the second flow of liquefied air and for sending it to the distillation, means for sending a variable flow of gaseous nitrogen from the system of columns to the first exchanger in order to condense it, means for sending the condensed nitrogen from the first exchanger to the nitrogen storage vessel, means for removing liquid nitrogen from the storage vessel and for sending it to the first exchanger in order to vaporize it, means for sending a flow of liquid oxygen from the system of columns to the oxygen storage vessel and means for sending liquid oxygen from the oxygen storage vessel to the second exchanger.

5. The installation of claim 4, in which the second exchanger is the main exchange line.

6. The installation of claim 4, in which only nitrogen and air originating from or intended for the air storage vessel exchange heat in the first exchanger.

7. The installation of claim 4, in which the liquid oxygen and the liquid air enter the respective storage vessel via the top of the storage vessel.

8. The installation of claim 4, in which the liquid nitrogen and the liquid air enter the respective storage vessel via the bottom of the storage vessel.

9. The installation of claim 4, further comprising means for sending the third flow of vaporized air to the distillation at a point upstream of the main exchange line and downstream of the purification unit, and optionally means for modifying the pressure of the third flow upstream of this point.
